(19) United States
(12) Patent Application Publication
(10) Pub. No.: US 2016/0147478 A1
(43) Pub. Date: May 26, 2016

(54) SYSTEM, METHOD AND RELAY DEVICE

(71) Applicant: FUJITSU LIMITED, Kawasaki-shi (JP)

(72) Inventor: Atsushi KATANO, Paderborn (DE)

(73) Assignee: FUJITSU LIMITED, Kawasaki-shi (JP)

(21) Appl. No.: 14/944,292

(22) Filed: Nov. 18, 2015

(30) Foreign Application Priority Data
Nov. 21, 2014 (JP) 2014-236419

(51) Int. Cl. G06F 3/06

(52) U.S. Cl. CPC G06F 3/0635; G06F 3/0604; G06F 3/0683

(57) ABSTRACT

A system includes relay devices each configured to make a relay between a plurality of storage devices and an external device by a channel. Each of the relay devices is configured to: determine a relay route via one of the relay device or the another relay device about each of pieces of specifying destination information in a correspondence relationship corresponding to the plurality of storage devices based on a relay load, notify the external device of the determined relay route, receive, from the external device, an access request allowed to be identified by specifying destination information determined in the external device based on the notified relay route, and execute processing relating to access to the storage device based on another specifying destination information in the correspondence relationship based on the access request and the correspondence relationship.

### CROSS-REFERENCE TO RELATED APPLICATION

This application is based upon and claims the benefit of priority of the prior Japanese Patent Application No. 2014-236419, filed on Nov. 21, 2014, the entire contents of which are incorporated herein by reference.

### FIELD

The embodiments discussed herein are related to a system, a method, and a relay device.

### BACKGROUND

As an external memory unit of a server or the like, a storage apparatus equipped with plural storage devices such as a hard disk drive (HDD) and a solid state drive (SSD) is known. Because of demands for increase in the memory capacity and improvement in the reliability, the storage apparatus is equipped with the storage devices at high density and is configured to make redundancy of access paths coupled to the storage devices. The storage apparatus includes plural relay devices (e.g. expanders) and thereby makes a relay, with redundancy, between an external device such as a server and the storage devices included at high density. Furthermore, the external device selects the access path made redundant to the storage device, which allows the storage apparatus to distribute the access load.

As examples of related arts, Japanese National Publication of International Patent Application No. 2007-536612, Japanese Laid-open Patent Publication No. 2012-73983, and Japanese Laid-open Patent Publication No. 2005-266933 are known.

### SUMMARY

According to an aspect of the invention, a system includes a first relay device including a first memory and configured to make a relay between a plurality of storage devices and an external device by a first channel; and a second relay device including a second memory and configured to make a relay between the plurality of storage devices and the external device by a second channel different from the first channel. Each of the first memory and the second memory is configured to store a correspondence relationship between first specifying destination information for executing access to a storage device in the plurality of storage devices and second specifying destination information for relaying access from the external device to the storage device to execute access to the storage device. Each of the first relay device and the second relay device is configured to: determine a relay route via one of the first relay device or the second relay device about each of pieces of the second specifying destination information corresponding to the plurality of storage devices based on a relay load, notify the external device of the determined relay route, receive, from the external device, an access request allowed to be identified by the second specifying destination information determined in the external device based on the notified relay route, and execute processing relating to access to the storage device based on the first specifying destination information based on the access request and the correspondence relationship.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates one example of a storage system of a first embodiment;

FIG. 2 illustrates one example of a storage system of a second embodiment;

FIG. 3 illustrates one example of a hardware configuration of an expander of the second embodiment;

FIG. 4 is a flowchart illustrating LUN number decision processing of the second embodiment;

FIG. 5 illustrates one example of a LUN number management table of the second embodiment;

FIG. 6 illustrates one example of a command sequence of coupling destination checks carried out to upper-level expanders by a server of the second embodiment;

FIG. 7 illustrates one example of a command sequence of coupling destination checks carried out to lower-level expanders by a server of the second embodiment;

FIG. 8 illustrates one example of a command sequence of LUN number acquisition carried out to upper-level expanders by a server of the second embodiment;

FIG. 9 is a flowchart illustrating recommended access path table generation processing of the second embodiment;

FIG. 10 illustrates one example of an expander state management table (assigned part) of the second embodiment;

FIG. 11 illustrates one example of an expander state management table (whole) of the second embodiment;

FIG. 12 is a flowchart illustrating recommended access path decision processing of the second embodiment;

FIG. 13 illustrates one example of a recommended access path table of the second embodiment;

FIG. 14 is a flowchart illustrating recommended access path notification processing of the second embodiment;

FIG. 15 illustrates one example of a command sequence of SSP Read access carried out to a disk by a server of the second embodiment;

FIG. 16 illustrates one example of an access device specifying list of the second embodiment; and

FIGS. 17, 18, 19, and 20 illustrate one example of recommended access paths in a DE of the second embodiment.

### DESCRIPTION OF EMBODIMENTS

The external device selects the access path depending on a coupling configuration set in advance in some cases. Furthermore, it is difficult for the external device to grasp the load of the access path in the storage apparatus. Therefore, the relay of access to the storage device in the storage apparatus is inefficient in many cases.

The embodiments discussed herein intend to efficiently relay access to the storage device.

The embodiments will be described in detail below with reference to the drawings.

### First Embodiment

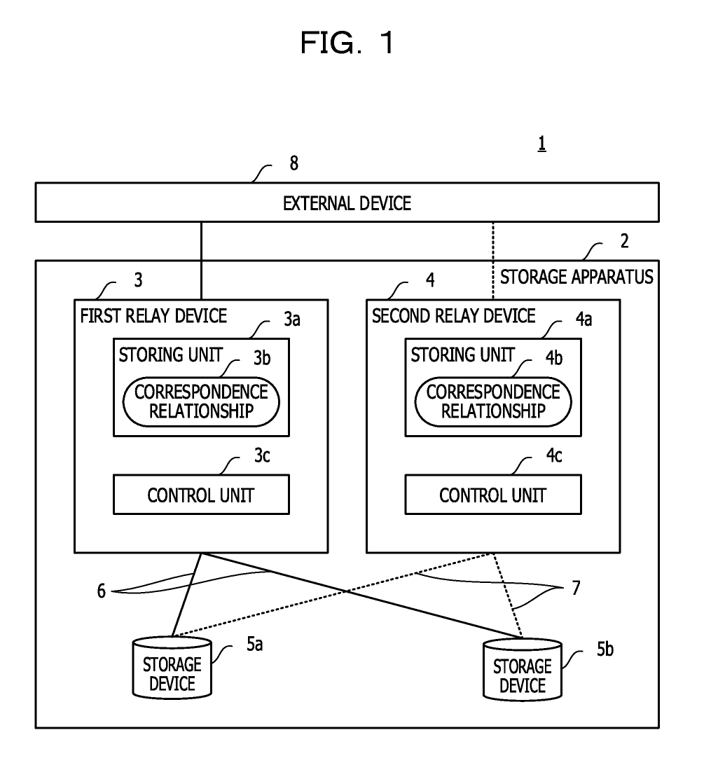

First, a storage system of a first embodiment will be described by using FIG. 1. FIG. 1 illustrates one example of a storage system of the first embodiment.

A storage system 1 includes a storage apparatus 2 and an external device 8. The storage apparatus 2 is an external memory unit of the external device 8 and is e.g. a drive enclosure. The external device 8 is an information processing device and is e.g. a server, a host, or the like.

The storage apparatus 2 includes a first relay device 3, a second relay device 4, and plural storage devices 5a and 5b. The first relay device 3 and the second relay device 4 are relay devices that relay access from the external device 8 to plural disks and are e.g. expanders. The storage devices 5a and 5b are memory devices such as an HDD and an SSD.

The first relay device 3 relays access from the external device 8 to the storage devices 5a and 5b by a first channel 6 (illustrated by solid lines). The second relay device 4 relays access from the external device 8 to the storage devices 5a and 5b by a second channel 7 (illustrated by dashed lines). In this manner, the storage apparatus 2 includes a redundant configuration in which the access paths to the storage devices 5a and 5b are reduplicated.

The storage apparatus 2 may include a hierarchical structure in which the first relay device 3 and the second relay device 4 are included as upper-level relay devices and a lower-level relay device is included between the first relay device 3 and the plural storage devices 5a and 5b and a lower-level relay device is included between the second relay device 4 and the plural storage devices 5a and 5b. In this case, the storage apparatus 2 can include the storage devices 5a and 5b at higher density on the basis of a tree topology.

The first relay device 3 includes a storing unit 3a and a control unit 3c. The storing unit 3a stores a correspondence relationship 3b between first specifying destination information and second specifying destination information.

The first specifying destination information is information for making access to the storage devices 5a and 5b. In other words, the first specifying destination information is information by which the storage devices 5a and 5b can be directly specified as an access destination. The first specifying destination information is e.g. the addresses of the storage devices 5a and 5b.

The second specifying destination information is information for relaying access from the external device 8 to the storage devices 5a and 5b to make the access to the storage devices 5a and 5b. In other words, the second specifying destination information is information by which the storage devices 5a and 5b can be indirectly specified as an access destination. The second specifying destination information is e.g. the logical unit number (LUN) of the storage devices 5a and 5b to which the first relay device 3 or the second relay device 4 relays access. The correspondence relationship 3b is information indicating the correspondence relationship between the first specifying destination information and the second specifying destination information.

The control unit 3c decides the relay route about each of the pieces of the second specifying destination information corresponding to the storage devices 5a and 5b on the basis of a relay load. The relay load is the load of relaying of the relay devices (first relay device 3 and second relay device 4) and includes a processing load, a communication load, and so forth. The relay route is the route by which access with the external device 8 is relayed. The first channel 6 by which the first relay device 3 makes a relay and the second channel 7 by which the second relay device 4 makes a relay are available as the relay route. For example, the control unit 3c decides the relay route of the second specifying destination information corresponding to the storage device 5a as the first channel 6, by which the first relay device 3 makes a relay, on the basis of the relay load. Furthermore, the control unit 3c decides the relay route of the second specifying destination information corresponding to the storage device 5b as the second channel 7, by which the second relay device 4 makes a relay, on the basis of the relay load.

The control unit 3c notifies the external device 8 of the decided relay route. This allows the external device 8 to acquire the relay route corresponding to the second specifying destination information regarding the storage devices 5a and 5b.

When accepting a request for access to the storage device 5a or 5b that can be identified by the second specifying destination information from the external device 8, the control unit 3c identifies the storage device 5a or 5b on the basis of the correspondence relationship 3b and relays the access request.

Furthermore, the second relay device 4 includes a storing unit 4a and a control unit 4c. The storing unit 4a stores a correspondence relationship 4b between the first specifying destination information and the second specifying destination information of the storage devices 5a and 5b. The correspondence relationship 4b is information indicating the correspondence relationship between the first specifying destination information and the second specifying destination information.

The control unit 4c decides the relay route about each of the pieces of the second specifying destination information corresponding to the storage devices 5a and 5b on the basis of the relay load. For example, the control unit 4c decides the relay route of the second specifying destination information corresponding to the storage device 5a as the first channel 6, by which the first relay device 3 makes a relay, on the basis of the relay load. Furthermore, the control unit 4c decides the relay route of the second specifying destination information corresponding to the storage device 5b as the second channel 7, by which the second relay device 4 makes a relay, on the basis of the relay load.

The control unit 4c notifies the external device 8 of the decided relay route. This allows the external device 8 to acquire the relay route corresponding to the second specifying destination information regarding the storage devices 5a and 5b.

When accepting a request for access to the storage device 5a or 5b that can be identified by the second specifying destination information from the external device 8, the control unit 4c identifies the storage device 5a or 5b on the basis of the correspondence relationship 4b and relays the access request.

This allows the external device 8 to employ the first relay device 3 or the second relay device 4 as an access destination and make a request for access to the storage device 5a or 5b identified by the second specifying destination information. Meanwhile, the storage apparatus 2 sets the direct access destination of the external device 8 to not the storage device 5a or 5b but the first relay device 3 or the second relay device 4 and thereby can control the access paths in the storage apparatus 2.

As above, the storage apparatus 2 can carry out relay control corresponding to the relay load in the storage apparatus 2 by guiding the external device 8 to access to the storage device 5a or 5b based on the second specifying destination information via the first relay device 3 or the second relay device 4. Therefore, the storage apparatus 2 can distribute the relay load attributed to the access to the storage devices 5a and 5b and efficiently relay the access to the storage devices 5a and 5b.

### Second Embodiment

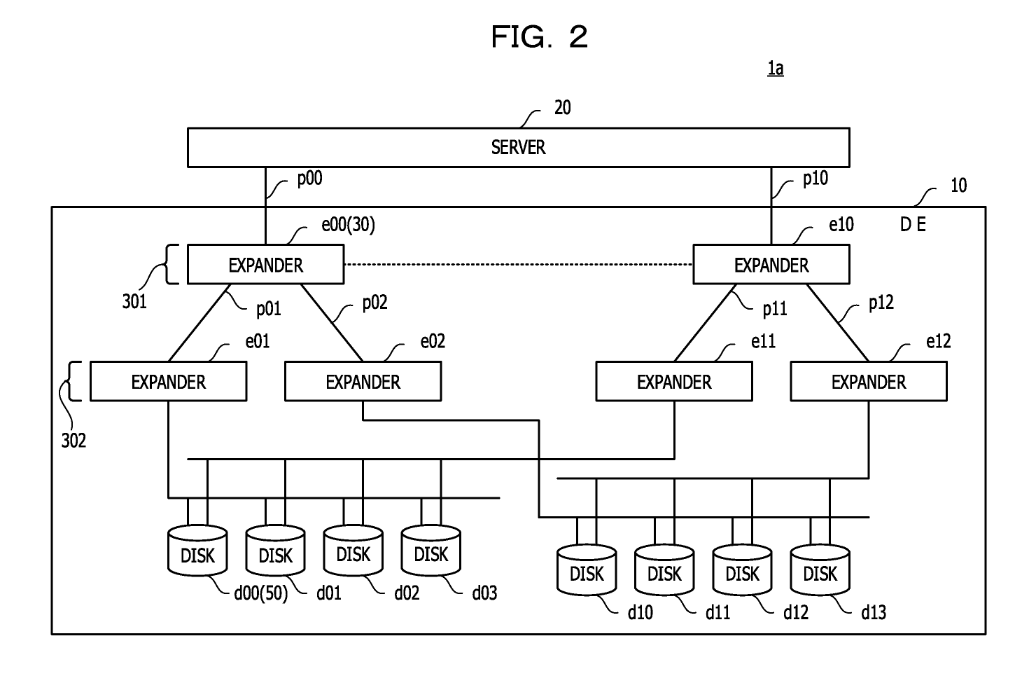

Next, a storage system of a second embodiment will be described by using FIG. 2. FIG. 2 illustrates one example of a storage system of the second embodiment.

A storage system is includes a drive enclosure (DE) 10 and a server 20. The DE 10 is an external memory unit coupled to the server 20 through an SAS (serial attached SCSI (small computer system interface)) interface and is one form of the storage apparatus 2 illustrated in the first embodiment. The server 20 is one form of the external device 8 illustrated in the first embodiment.

The DE 10 includes expanders 30 (e00, e10, e01, e02, e11, and e12) and disks 50 (d00, d01, d02, d03, d10, d11, d12, and d13). The DE 10 has plural slots and the disks 50 are set in the respective slots.

The disks 50 are end devices coupled (illustrated by solid lines) through SAS interfaces and are each e.g. an SAS HDD or an SAS SSD. The DE 10 includes eight disks 50 as one example. However, this is for a simplified description and the number of disks 50 is not limited to eight.

The expanders 30 are relay devices that can extend the number of coupled devices. For example, the expanders 30 are SAS switches and the SAS switches can be cascade-coupled. The DE 10 employs the expanders e00 and e10 as upper-level expanders 301 coupled to the server 20, and employs the expanders e01, e02, e11, and e12 as lower-level expanders 302 coupled to the server 20 with the intermediary of the upper-level expanders 301. The lower-level expanders 302 are coupled to the disks d00, d01, d02, d03, d10, d11, d12, and d13. Although the DE 10 has a two-stage configuration with the upper-level expanders 301 and the lower-level expanders 302, the DE 10 may have a multi-stage configuration in which the expanders 30 at three or more stages are coupled.

The expander e00 is coupled to the server 20 by a path p00. Furthermore, the expander e00 is coupled to the expander e01 by a path p01 and is coupled to the expander e02 by a path p02. The expander e01 is coupled to each of the disks 50 in one group (first group), i.e. the disks d00, d01, d02, and d03, among all disks 50. The expander e02 is coupled to each of the disks 50 in one group (second group), i.e. the disks d10, d11, d12, and d13, among all disks 50. This enables the expander e00 to relay access from the server 20 to the disk 50.

The expander e10 is coupled to the server 20 by a path p10. Furthermore, the expander e10 is coupled to the expander e11 by a path p11 and is coupled to the expander e12 by a path p12. The expander e11 is coupled to each of the disks 50 in one group (first group), i.e. the disks d00, d01, d02, and d03, among all disks 50. The expander e12 is coupled to each of the disks 50 in one group (second group), i.e. the disks d10, d11, d12, and d13, among all disks 50. This enables the expander e10 to relay access from the server 20 to the disk 50.

Therefore, the DE 10 includes access paths that couple the server 20 to the disks 50 on the basis of a tree topology having the expander e00 as a route. Furthermore, the DE 10 includes access paths that couple the server 20 to the disks 50 on the basis of a tree topology having the expander e10 as a route. As above, the DE 10 includes a redundant configuration in which the access paths are reduplicated.

Furthermore, the DE 10 couples the expander e00 to the expander e10 through an inter integrated circuit (I2C) interface (illustrated by a dashed line) to allow the expander e00 and the expander e10 to communicate independently of the SAS interface.

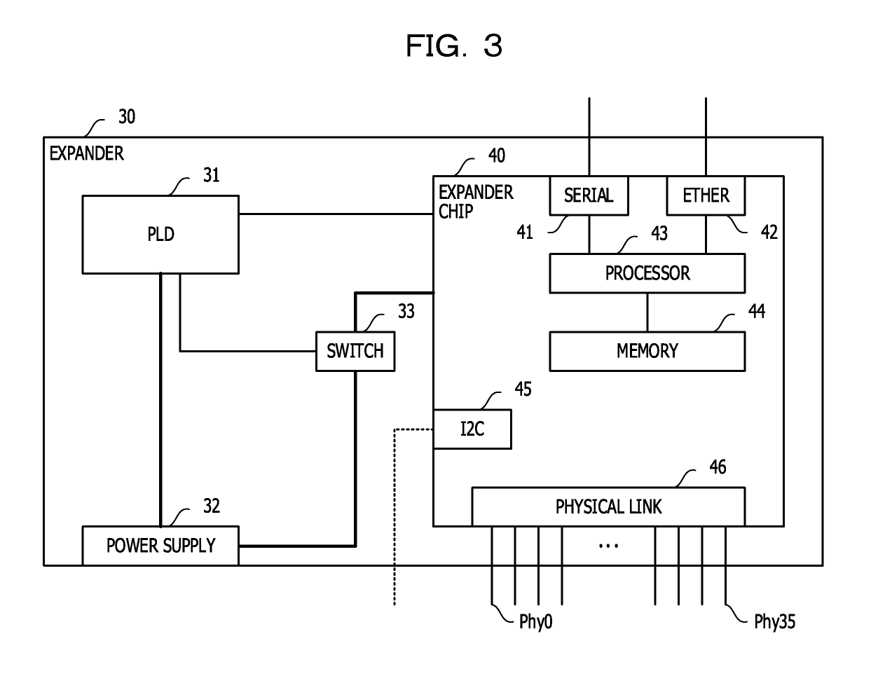

Next, a hardware configuration of an expander of the second embodiment will be described by using FIG. 3. FIG. 3 illustrates one example of a hardware configuration of an expander of the second embodiment. The expander depicted in FIG. 3 may be the expander 30 depicted in FIG. 2.

The expander 30 includes a programmable logic device (PLD) 31, a power supply 32, a switch 33, and an expander chip 40. The PLD 31 includes a function as a power supply control device that operates by a standby power supply and switches the input/output state of the power supply 32 to the expander chip 40 in response to an input signal from the switch 33.

The expander chip 40 includes a serial interface (Serial) 41, an Ethernet (registered trademark) interface (Ether) 42, a processor 43, a memory 44, an I2C interface 45, and a physical link 46.

The serial interface 41 and the Ethernet interface 42 are equipment coupling interfaces to which peripheral equipment for maintenance and management such as debugging is coupled. The I2C interface 45 is a communication interface between the upper-level expanders 301. The physical link 46 includes physical ports from Phy0 to Phy35 and is coupled to the disks 50 or other expanders 30 as an SAS physical link (SAS interface).

The processor 43 functions as a control unit of the expander chip 40. The memory 44 and plural pieces of peripheral equipment are coupled to the processor 43 via a bus. The processor 43 may be a multi-core processor constructed with two or more processors.

The processor 43 is e.g. a central processing unit (CPU), a micro processing unit (MPU), a digital signal processor (DSP), an application specific integrated circuit (ASIC), or a PLD.

The memory 44 functions as a storing unit of the expander 30. The memory 44 includes a volatile memory and a non-volatile memory. For example, the volatile memory is a random access memory (RAM) and the non-volatile memory is a read only memory (ROM).

In the non-volatile memory, a program of an operating system (OS), application programs, and various kinds of data are stored. In the volatile memory, at least part of the program of the OS and the application program to be executed by the processor 43 is temporarily stored. Furthermore, various kinds of data for processing by the processor 43 are stored in the volatile memory. In addition, the volatile memory functions as a cache memory of the processor 43.

The equipment coupling interface is a communication interface for coupling peripheral equipment to the expander 30. For example, a memory device and a memory reader/writer (not illustrated) can be coupled to the equipment coupling interface. The memory device is a recording medium equipped with a function of communications with the equipment coupling interface. The memory reader/writer is a device that carries out writing of data to a memory card or reading of data from the memory card. The memory card is e.g. a recording medium of a card type.

Furthermore, a monitor (not illustrated) may be coupled to the equipment coupling interface. In this case, the equipment coupling interface has a graphic processing function to display images on a screen of the monitor in accordance with a command from the processor 43.

In addition, a keyboard or a mouse (not illustrated) may be coupled to the equipment coupling interface. In this case, the equipment coupling interface transmits a signal sent from the keyboard or the mouse to the processor 43. The mouse is one example of a pointing device and it is also possible to use another pointing device. As another pointing device, a touch panel, a tablet, a touch pad, a trackball, etc. are available.

Moreover, an optical drive device (not illustrated) may be coupled to the equipment coupling interface. The optical drive device reads data recorded in an optical disc by using laser light or the like. The optical disc is a portable recording medium in which data is so recorded as to be readable by light reflection. Among the optical discs are a digital versatile disc (DVD), a DVD-RAM, a compact disc read only memory (CD-ROM), a CD-R (recordable)/RW (rewritable), etc.

By the above hardware configuration, the processing functions of the expander 30 of the second embodiment can be implemented. The processing functions of the expander 30 carry out e.g. SAS control, physical layer (Phy) control, serial management protocol (SMP) control, serial SCSI protocol (SSP) control, and various kinds of control.

The first relay device 3 and the second relay device 4 illustrated in the first embodiment can also be implemented by hardware similar to the hardware of the expander 30 illustrated in FIG. 3.

The expander 30 implements the processing functions of the second embodiment by executing a program recorded in a computer-readable recording medium for example. The program that describes the contents of processing to be executed by the expander 30 can be recorded in various recording media. For example, the program to be executed by the expander 30 can be stored in the memory 44. The processor 43 loads at least part of the program in the memory 44 into the volatile memory and executes the program. Furthermore, it is also possible to record a program to be executed by the expander 30 in a portable recording medium such as an optical disc, a memory device, or a memory card. The program stored in the portable recording medium becomes executable after being installed in the memory 44 by control from the processor 43 for example. Furthermore, it is also possible that the processor 43 directly reads out the program from the portable recording medium and executes the program.

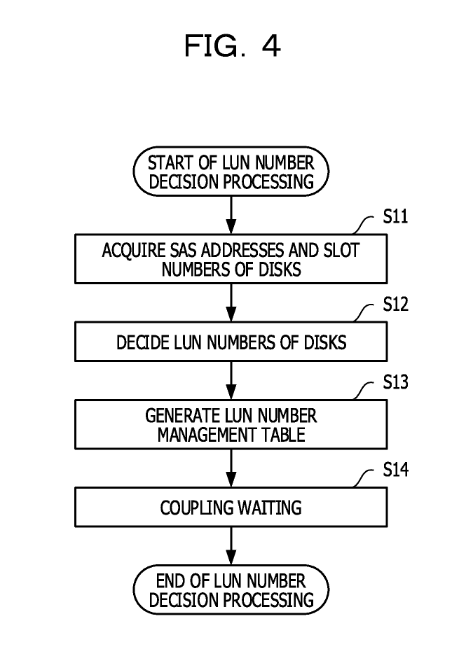

Next, LUN number decision processing of the second embodiment will be described by using FIG. 4. FIG. 4 is a flowchart illustrating the LUN number decision processing of the second embodiment.

The LUN number decision processing is processing of deciding LUN numbers. The LUN number is information as an indirect specifying destination of the disk 50. The LUN number decision processing is executed by the control unit (processor 43) possessed by the upper-level expander 301 at the time of initialization processing of the expander 30 (e.g. at the time of power activation). Whether or not the expander 30 is the upper-level expander 301 may be set in advance at the time of shipping or by an administrator or may be decided from the mutual coupling relationship of the expanders 30.

[Step S11] The control unit acquires the SAS addresses and the slot numbers of the disks 50 through the lower-level expanders 302. The SAS address is unique information assigned to an SAS device and is equivalent to a direct specifying destination by which the server 20 can directly specify the disk 50. The slot number is a unique number assigned to the slot in which the disk 50 is set.

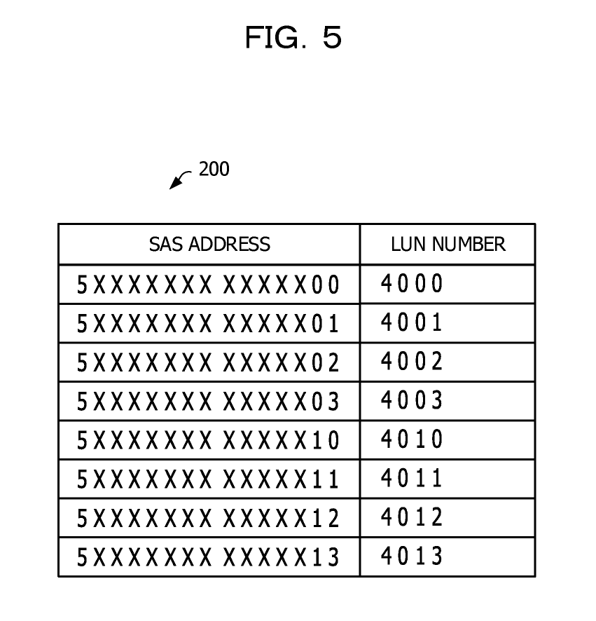

For example, the control unit of the expander e00, which is the upper-level expander 301, issues an SAS frame “SMP DISCOVER REQUEST FUNCTION” to the expanders e01 and e02, which are the lower-level expanders 302. This allows the control unit of the expander e00 to acquire the SAS addresses and the slot numbers of the disks 50. Furthermore, the control unit of the expander e10, which is the upper-level expander 301, issues the SAS frame “SMP DISCOVER REQUEST FUNCTION” to the expanders e11 and e12, which are the lower-level expanders 302. This allows the control unit of the expander e10 to acquire the SAS addresses and the slot numbers of the disks 50.

[Step S12] The control unit decides the LUN numbers of the disks 50 in accordance with a given LUN number giving rule. The LUN number is a unique number assigned to the disk 50 and is equivalent to an indirect specifying destination by which the server 20 can indirectly specify the disk 50.

[Step S13] The control unit generates a LUN number management table. The LUN number management table is information indicating the correspondence relationship between the SAS address and the LUN number about each disk 50. The LUN number management table will be described later by using FIG. 5.

[Step S14] The control unit makes transition of the control state of the corresponding expander 30 to a coupling waiting state in which the expander 30 waits for coupling of the server 20, and ends the LUN number decision processing.

In this manner, the upper-level expander 301 can associate the SAS address and the LUN number of the disk 50 with each other. The two upper-level expanders 301 may generate the LUN number management table independently of each other. Furthermore, the LUN number management table may be a table that is generated by one of the two upper-level expanders 301 and thereafter is shared by both of the two upper-level expanders 301.

Next, one example of the LUN number management table of the second embodiment will be described by using FIG. 5. FIG. 5 illustrates one example of the LUN number management table of the second embodiment.

A LUN number management table 200 includes the SAS address and the LUN number as items. For example, an SAS address “5XXXXXXX XXXXXX00” and a LUN number “4000” are in a corresponding relationship and are information of the same disk 50 (e.g. d00). Similarly, the LUN number management table 200 includes the correspondence relationships between the SAS addresses and the LUN numbers of all disks 50 mounted in the DE 10.

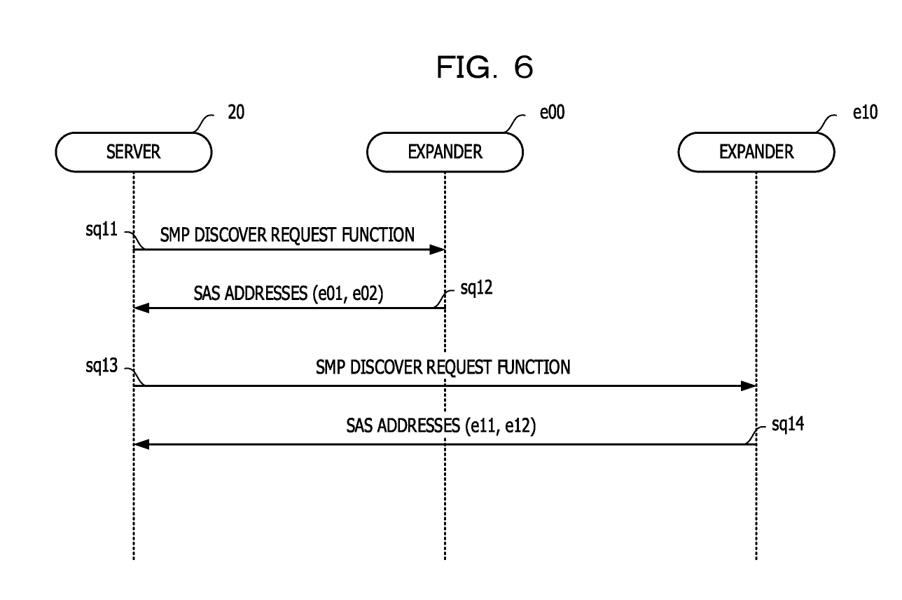

Next, recognition of the disks 50 when the server 20 is coupled to the DE 10 will be described by using FIGS. 6, 7, and 8. First, coupling destination checks carried out to the upper-level expanders 301 by the server 20 will be described by using FIG. 6. FIG. 6 illustrates one example of a command sequence of the coupling destination checks carried out to the upper-level expanders 301 by the server 20 of the second embodiment.

At the time of the coupling to the DE 10, the server 20 recognizes the upper-level expanders 301 to which the server 20 is to be directly coupled, and makes an inquiry to the upper-level expanders 301 about the coupling destinations of the upper-level expanders 301. The following description will be made according to the command sequence illustrated in FIG. 6.

[Sequence sq11] The server 20 issues the SAS frame “SMP DISCOVER REQUEST FUNCTION” to the expander e00, which is one of the upper-level expanders 301, as the coupling destination check.

[Sequence sq12] The expander e00 returns, to the server 20, the SAS addresses of the lower-level expanders 302 coupled to the expander e00 as a response to the SAS frame “SMP DISCOVER REQUEST FUNCTION.” For example, because being coupled to the expanders e01 and e02 as the lower-level expanders 302, the expander e00 returns the SAS addresses of the expanders e01 and e02 to the server 20.

[Sequence sq13] The server 20 issues the SAS frame “SMP DISCOVER REQUEST FUNCTION” to the expander e10, which is the other of the upper-level expanders 301, as the coupling destination check.

[Sequence sq14] The expander e10 returns, to the server 20, the SAS addresses of the lower-level expanders 302 coupled to the expander e10 as a response to the SAS frame “SMP DISCOVER REQUEST FUNCTION.” For example, because being coupled to the expanders e11 and e12 as the lower-level expanders 302, the expander e10 returns the SAS addresses of the expanders e11 and e12 to the server 20.

This allows the server 20 to acquire the SAS addresses of the lower-level expanders 302.

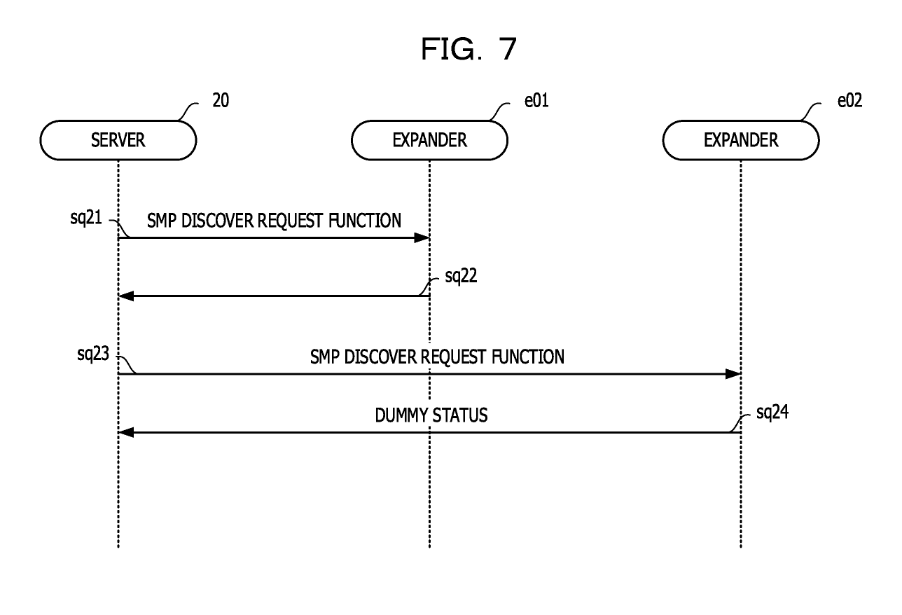

Next, coupling destination checks carried out to the lower-level expanders 302 by the server 20 will be described by using FIG. 7. FIG. 7 illustrates one example of a command sequence of the coupling destination checks carried out to the lower-level expanders 302 by the server 20 of the second embodiment.

After the coupling destination checks of the upper-level expanders 301, the server 20 makes an inquiry to the lower-level expanders 302 as the coupling destinations of the upper-level expanders 301 about the coupling destinations of the lower-level expanders 302. The following description will be made according to the command sequence illustrated in FIG. 7.

[Sequence sq21] The server 20 issues the SAS frame “SMP DISCOVER REQUEST FUNCTION” to the expander e01, which is one of the lower-level expanders 302 of the expander e00, as the coupling destination check.

[Sequence sq22] The expander e01 detects that the server 20 is compliant with SCSI Target Port Group and returns a dummy status as a response to the SAS frame “SMP DISCOVER REQUEST FUNCTION.” The dummy status is a response indicating that a lower-level device coupled to the expander e01 does not exist (“No Device Attached”). The expander e01 thereby suppresses direct recognition of the disks 50 by the server 20. If the server 20 is not compliant with SCSI Target Port Group, the expander e01 returns, to the server 20, the SAS addresses of the disks d00, d01, d02, and d03 as lower-level devices coupled to the expander e01.

[Sequence sq23] The server 20 issues the SAS frame “SMP DISCOVER REQUEST FUNCTION” to the expander e02, which is the other of the lower-level expanders 302 of the expander e00, as the coupling destination check.

[Sequence sq24] The expander e02 detects that the server 20 is compliant with SCSI Target Port Group and returns a dummy status as a response to the SAS frame “SMP DISCOVER REQUEST FUNCTION.” The dummy status is a response indicating that a lower-level device coupled to the expander e02 does not exist.

The expander e02 thereby suppresses direct recognition of the disks 50 by the server 20. If the server 20 is not compliant with SCSI Target Port Group, the expander e02 returns, to the server 20, the SAS addresses of the disks d10, d11, d12, and d13 as lower-level devices coupled to the expander e02.

Although the command sequence along which the server 20 carries out the coupling destination checks to the expanders e01 and e02 is described, a command sequence along which the server 20 carries out coupling destination checks to the expanders e11 and e12 is also similar to this command sequence.

Due to this, if the server 20 is compliant with SCSI Target Port Group, the lower-level expanders 302 can keep the SAS addresses as the direct specifying destinations of the disks 50 secret from the server 20. Keeping the SAS addresses secret from the server 20 restricts the server 20 from directly accessing the disks 50. Furthermore, if the server 20 is not compliant with SCSI Target Port Group, the lower-level expanders 302 can disclose the SAS addresses as the direct specifying destinations of the disks 50 to the server 20.

The lower-level expanders 302 return the SAS addresses and the slot numbers in response to the SAS frame “SMP DISCOVER REQUEST FUNCTION” from the upper-level expander 301. That is, the lower-level expanders 302 can identify the issuance source of the SAS frame “SMP DISCOVER REQUEST FUNCTION” and change the contents of the response. This blocks the server 20 from acquiring the SAS addresses of the disks 50. Furthermore, the upper-level expanders 301 can acquire the SAS addresses and the slot numbers of the disks 50.

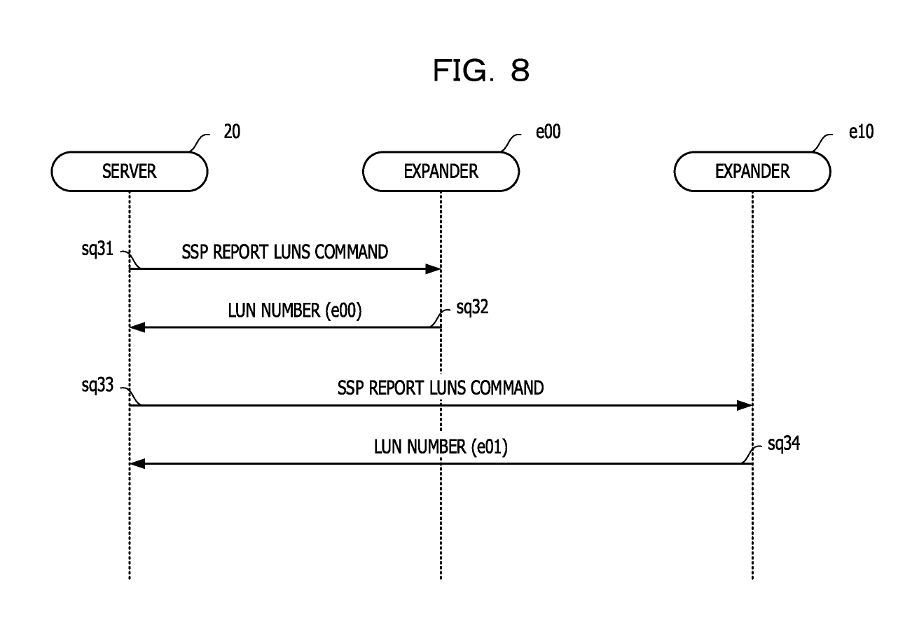

Next, LUN number acquisition carried out to the upper-level expanders 301 by the server 20 will be described by using FIG. 8. FIG. 8 illustrates one example of a command sequence of the LUN number acquisition carried out to the upper-level expanders 301 by the server 20 of the second embodiment.

Because it is difficult for the server 20 to check the coupling destinations of the lower-level expanders 302 (i.e. disks 50), the server 20 carries out, to the upper-level expanders 301, acquisition of the LUN numbers of logical volumes associated with the upper-level expanders 301. The following description will be made according to the command sequence illustrated in FIG. 8.

[Sequence sq31] The server 20 issues a SCSI command “SSP REPORT LUNS COMMAND” as a request for acquisition of the LUN numbers to the expander e00, which is one of the upper-level expanders 301.

[Sequence sq32] The expander e00 returns the LUN numbers of the logical volumes associated with the expander e00 to the server 20. The expander e00 can return the LUN numbers in accordance with the LUN number management table.

[Sequence sq33] The server 20 issues the SCSI command “SSP REPORT LUNS COMMAND” as a request for acquisition of the LUN numbers to the expander e10, which is the other of the upper-level expanders 301.

[Sequence sq34] The expander e10 returns the LUN numbers of the logical volumes associated with the expander e10 to the server 20. The expander e10 can return the LUN numbers in accordance with the LUN number management table.

This allows the server 20 to recognize the disks 50 of the DE 10 as the logical volumes associated with the upper-level expanders 301. Therefore, the expander e00 can expect the server 20 to make access addressed to the expander e00 about the disk 50 corresponding to the LUN number returned to the server 20. Furthermore, the expander e10 can expect the server 20 to make access addressed to the expander e10 about the disk 50 corresponding to the LUN number returned to the server 20.

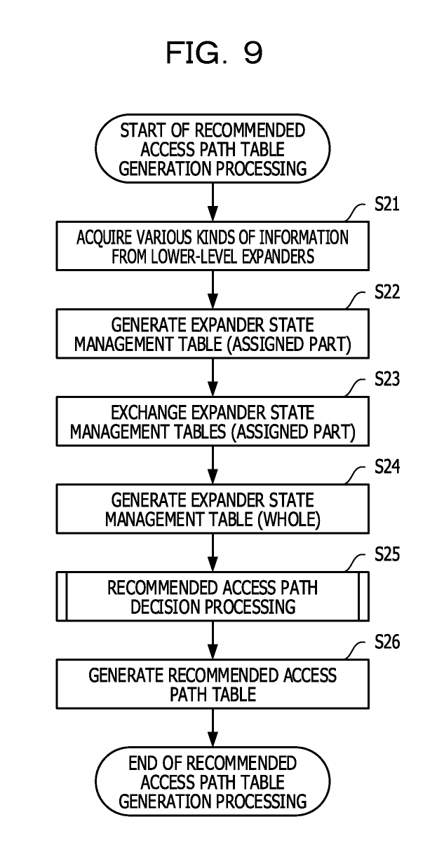

Next, recommended access path table generation processing of the second embodiment will be described by using FIG. 9. FIG. 9 is a flowchart illustrating the recommended access path table generation processing of the second embodiment.

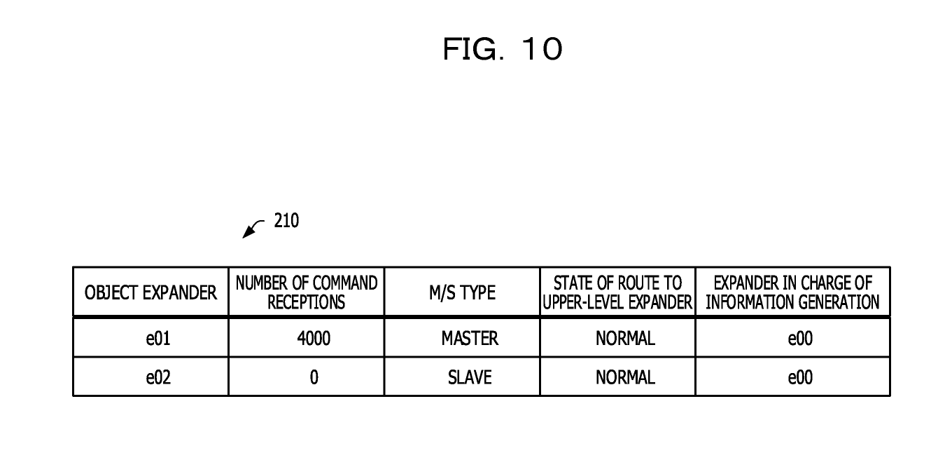

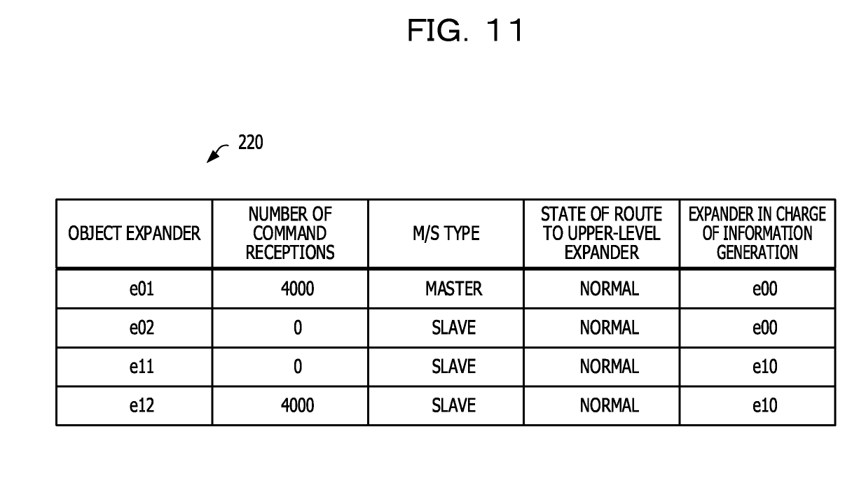

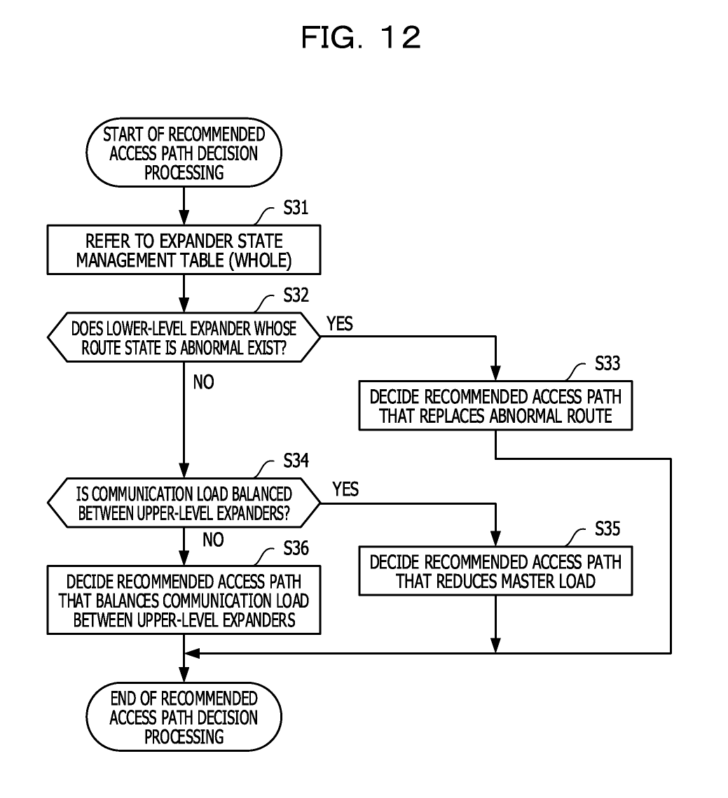

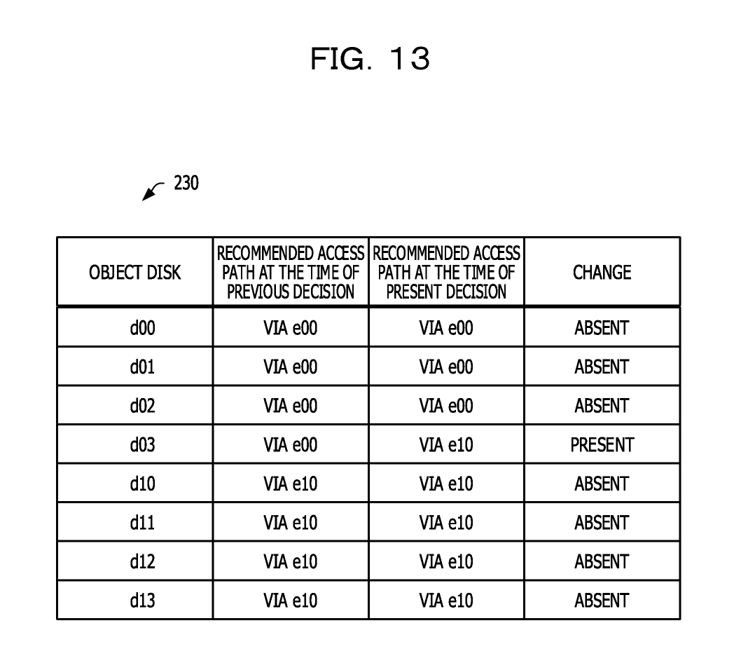

The recommended access path table generation processing is processing of generating a recommended access path table. The recommended access path table is information indicating a recommended access path of each disk 50, i.e. each logical volume. The recommended access path is an access path to the logical volume recommended to the server 20 and includes specifying of the upper-level expander 301 through which the access path runs. The recommended access path table generation processing is executed by the control unit (processor 43) possessed by the upper-level expander 301 in response to a timer trigger (e.g. every given time) or an event trigger (e.g. detection of a given state change).

[Step S21] The control unit acquires various kinds of information used to generate a recommended access path table from the lower-level expanders 302. For example, among the various kinds of information used to generate a recommended access path table are the number of command receptions, a role, the route state, and so forth.

[Step S22] The control unit generates an expander state management table (assigned part) on the basis of the acquired various kinds of information. The expander state management table (assigned part) will be described later by using FIG. 10.

[Step S23] The control unit exchanges the generated expander state management tables (assigned part) with the other upper-level expander 301.

[Step S24] The control unit generates an expander state management table (whole) from the generated expander state management table (assigned part) and the expander state management table (assigned part) acquired from the other upper-level expander 301. The control unit stores the generated expander state management table (whole) in the memory 44 for example. The expander state management table (whole) will be described later by using FIG. 11.

[Step S25] The control unit executes recommended access path decision processing. The recommended access path decision processing is processing of deciding the recommended access paths. The recommended access path decision processing will be described later by using FIG. 12.

[Step S26] The control unit generates a recommended access path table on the basis of the decided recommended access paths and ends the recommended access path table generation processing. The control unit stores the generated recommended access path table in the memory 44 for example. The recommended access path table will be described later by using FIG. 13.

Next, the expander state management table (assigned part) generated in the step S22 of the recommended access path table generation processing will be described by using FIG. 10. FIG. 10 illustrates one example of the expander state management table (assigned part) of the second embodiment.

An expander state management table 210 is one example of the expander state management table (assigned part). The expander state management table 210 includes, as items, the object expander, the number of command receptions, the M/S type, the state of the route to the upper-level expander, and the expander in charge of information generation. The object expander indicates the lower-level expander 302 equivalent to a subordinate to the expander in charge of information generation as the upper-level expander 301. The number of command receptions indicates the communication load of the object expander per unit time. The number of command receptions is one example of the communication load and the communication load of the object expander may be indicated by the number of command transmissions, the number of command relays, a combination of them, or the like.

The M/S type is the type of the expander 30 and Master (master) and Slave (slave) exist as the types. One expander 30 among the plural expanders 30 serves as the master and the other expanders 30 serve as the slaves. For example, the M/S type is set in advance. The master monitors and collects environmental information of the DE 10 (internal temperature of the DE 10, the state of a fan and a power supply, and so forth). Furthermore, the master carries out notifying to the server 20 when abnormality is detected, a response to a request from the server 20, and so forth by using a SCSI command, SCSI enclosure service (SES). Therefore, the load of the master is large compared with the slave.

The state of the route to the upper-level expander indicates the state of the access path between the object expander and the upper-level expander 301. As the state, a normal state and an abnormal state exist. The expander in charge of information generation indicates the upper-level expander 301 in charge of generation of the expander state management table (assigned part).

For example, the expander state management table 210 indicates that the number of command receptions of the expander e01 is “4000” and the M/S type is the “master” and the state of the route to the upper-level expander is the “normal.” Furthermore, the expander state management table 210 indicates that the number of command receptions of the expander e02 is “0” and the M/S type is the “slave” and the state of the route to the upper-level expander is the “normal.” The expander in charge of information generation in the expander state management table 210 is the expander e00 as one of the upper-level expanders 301. The expander e10, which is the other of the upper-level expanders 301, also generates the expander state management table (assigned part).

Next, the expander state management table (whole) generated in the step S24 of the recommended access path table generation processing will be described by using FIG. 11. FIG. 11 illustrates one example of the expander state management table (whole) of the second embodiment. An expander state management table 220 is one example of the expander state management table (whole). The expander state management table (whole) includes the same configuration as the expander state management table (assigned part).

The expander state management table 220 is an expander state management table generated by merging the expander state management table (assigned part) generated by the expander e00 and the expander state management table (assigned part) generated by the expander e10.

Therefore, the expander state management table 220 includes information that is collected by the expander e00 and relates to the expanders e01 and e02 and information that is collected by the expander e10 and relates to the expanders e11 and e12.

Next, the recommended access path decision processing will be described by using FIG. 12. FIG. 12 is a flowchart illustrating the recommended access path decision processing of the second embodiment. The recommended access path decision processing is processing of deciding recommended access paths. The recommended access path decision processing is executed by the control unit (processor 43) possessed by the upper-level expander 301 in the step S25 of the recommended access path table generation processing.

[Step S31] The control unit refers to the expander state management table (whole).

[Step S32] The control unit determines whether or not the “abnormal” state exists as the state of the route to the upper-level expander 301 about the lower-level expanders 302. The control unit proceeds to a step S33 if the lower-level expander 302 whose state of the route is “abnormal” exists, and proceeds to a step S34 if the lower-level expander 302 whose state of the route is “abnormal” does not exist.

[Step S33] The control unit decides a recommended access path that replaces the abnormal route and ends the recommended access path decision processing.

For example, if the route state is “abnormal” between the expanders e00 and e01, the control unit decides the recommended access path via the expander e10 about the disks d00, d01, d02, and d03 and decides the recommended access path via the expander e00 about the disks d10, d11, d12, and d13. Furthermore, if the route state is “abnormal” between the expanders e00 and e02, the control unit decides the recommended access path via the expander e00 about the disks d00, d01, d02, and d03 and decides the recommended access path via the expander e10 about the disks d10, d11, d12, and d13. Moreover, if the route state is “abnormal” between the expanders e10 and e11, the control unit decides the recommended access path via the expander e00 about the disks d00, d01, d02, and d03 and decides the recommended access path via the expander e10 about the disks d10, d11, d12, and d13. In addition, if the route state is “abnormal” between the expanders e10 and e12, the control unit decides the recommended access path via the expander e10 about the disks d00, d01, d02, and d03 and decides the recommended access path via the expander e00 about the disks d10, d11, d12, and d13.

[Step S34] The control unit determines whether or not the communication load is balanced between the upper-level expanders 301. The control unit proceeds to a step S35 if the communication load is balanced between the upper-level expanders 301, and proceeds to a step S36 if the communication load is not balanced between the upper-level expanders 301. The determination of whether or not the communication load is balanced can be carried out by comparing the sum of the number of command receptions of the expander e01 and the number of command receptions of the expander e02 with the sum of the number of command receptions of the expander e11 and the number of command receptions of the expander e12. The control unit can determine that the communication load is balanced between the upper-level expanders 301 when the difference between the two sums falls within a given range.

[Step S35] Because the communication load is balanced between the upper-level expanders 301, the control unit decides the recommended access path that reduces the load of the expander 30 that serves as the master and ends the recommended access path decision processing.

For example, if the expander e01 serves as the master, the control unit changes part of the recommended access paths via the expander e00 in the recommended access paths of the disks d00, d01, d02, and d03 to the recommended access path via the expander e10. Furthermore, if the expander e02 serves as the master, the control unit changes part of the recommended access paths via the expander e00 in the recommended access paths of the disks d10, d11, d12, and d13 to the recommended access path via the expander e10. Moreover, if the expander e11 serves as the master, the control unit changes part of the recommended access paths via the expander e10 in the recommended access paths of the disks d00, d01, d02, and d03 to the recommended access path via the expander e00. In addition, if the expander e12 serves as the master, the control unit changes part of the recommended access paths via the expander e10 in the recommended access paths of the disks d10, d11, d12, and d13 to the recommended access path via the expander e00.

This allows the control unit to distribute the load of the expander 30 that serves as the master to the expander 30 that does not serve as the master. The number of changes of the recommended access paths may be set in advance (e.g. the number of changes is “1”) or may be decided according to various kinds of parameters held by the expander state management table (whole) (e.g. the number of changes is “2”). Furthermore, the change of the recommended access path is one example of the distribution of the load of the expander 30 that serves as the master, and recombination of the recommended access paths or the like may be employed.

[Step S36] Because the communication load is not balanced between the upper-level expanders 301, the control unit decides the recommended access path that achieves the balance of the communication load between the upper-level expanders 301 and ends the recommended access path decision processing.

For example, if the communication load of the expander e00 is higher than the communication load of the expander e10, the control unit compares the communication loads of the lower-level expanders 302 (e01 and e02) of the expander e00. If the communication load of the expander e01 is higher, the control unit sets the number of recommended access paths via the expander e10 larger by a given number (e.g. two) than the number of recommended access paths via the expander e00 in the recommended access paths of the disks d00, d01, d02, and d03. Furthermore, if the communication load of the expander e02 is higher, the control unit sets the number of recommended access paths via the expander e10 larger by a given number (e.g. two) than the number of recommended access paths via the expander e00 in the recommended access paths of the disks d10, d11, d12, and d13. On the other hand, if the communication load of the expander e10 is higher than the communication load of the expander e00, the control unit compares the communication loads of the lower-level expanders 302 (e11 and e12) of the expander e10. If the communication load of the expander e11 is higher, the control unit sets the number of recommended access paths via the expander e00 larger by a given number (e.g. two) than the number of recommended access paths via the expander e10 in the recommended access paths of the disks d00, d01, d02, and d03. Furthermore, if the communication load of the expander e12 is higher, the control unit sets the number of recommended access paths via the expander e00 larger by a given number (e.g. two) than the number of recommended access paths via the expander e10 in the recommended access paths of the disks d10, d11, d12, and d13.

This allows the control unit to decide the recommended access paths according to the loads of the expanders 30. The control unit may evaluate the respective parameters (the route states, the processing loads of the expanders 30, and the communication loads of the expanders 30) and decide the recommended access paths from a comprehensive evaluation of two or more parameters.

Next, the recommended access path table generated in the step S26 of the recommended access path table generation processing will be described by using FIG. 13. FIG. 13 illustrates one example of the recommended access path table of the second embodiment. A recommended access path table 230 is one example of the recommended access path table generated by the control unit. The recommended access path table 230 includes, as items, the object disk, the recommended access path at the time of the previous decision, the recommended access path at the time of the present decision, and change.

The recommended access path at the time of the previous decision indicates the recommended access path decided previous time in the recommended access path table generation processing. The recommended access path at the time of the present decision indicates the recommended access path decided present time in the recommended access path table generation processing. The change indicates whether a change is present between the recommended access path at the time of the previous decision and the recommended access path at the time of the present decision. At the time of the initial generation of the recommended access path table, the change is set “present” about all object disks.

For example, in the case of the disk d00, the recommended access path at the time of the previous decision is via the expander e00 and the recommended access path at the time of the present decision is via the expander e00, which indicates that a change is absent between the recommended access path at the time of the previous decision and the recommended access path at the time of the present decision. Furthermore, in the case of the disk d03, the recommended access path at the time of the previous decision is via the expander e00 and the recommended access path at the time of the present decision is via the expander e10, which indicates that a change is present between the recommended access path at the time of the previous decision and the recommended access path at the time of the present decision.

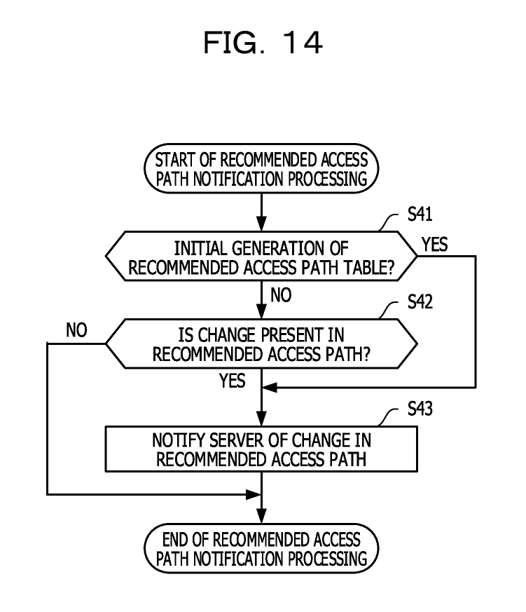

Next, recommended access path notification processing will be described by using FIG. 14. FIG. 14 is a flowchart illustrating recommended access path notification processing of the second embodiment. The recommended access path notification processing is processing of notifying the server 20 of recommended access paths. The recommended access path notification processing is executed by the control unit (processor 43) possessed by the upper-level expander 301 every time the recommended access path table generation processing is executed.

[Step S41] The control unit determines whether or not the present table generation is the initial generation of the recommended access path table. The control unit proceeds to a step S43 if the present table generation is the initial generation of the recommended access path table, and proceeds to a step S42 if the present table generation is not the initial generation of the recommended access path table.

[Step S42] The control unit refers to the recommended access path table and determines whether a change in the recommended access path is present. The control unit proceeds to the step S43 if a change is present in the recommended access path, and ends the recommended access path notification processing if a change is absent.

[Step S43] The control unit notifies the server 20 of that a change is present in the recommended access path, and ends the recommended access path notification processing.

This allows the server 20 to acquire the change in the recommended access path if the change is present in the recommended access path.

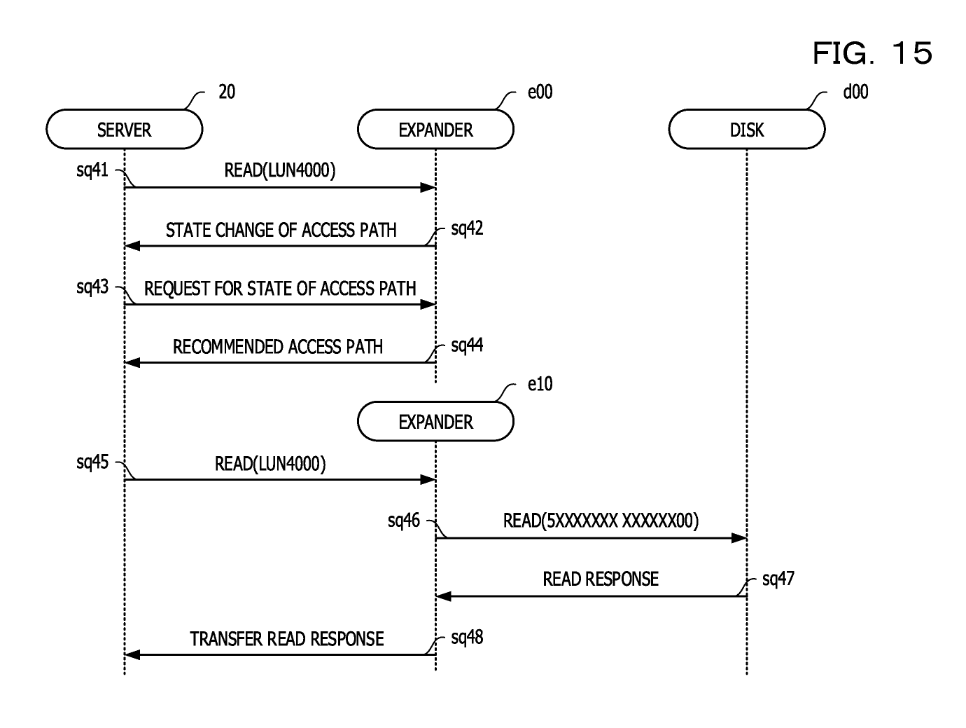

Next, a description will be made by using FIG. 15 about access from the server 20 to the disk 50 and notification of a change in the recommended access path from the upper-level expander 301 to the server 20. FIG. 15 illustrates one example of a command sequence of SSP Read access carried out to the disk 50 by the server 20 of the second embodiment. The command sequence illustrated in FIG. 15 represents a case in which the server 20 accesses the disk d00 via the expander e00 as one of the upper-level expanders 301. This command sequence is the same also when the server 20 accesses the disk d00 via the other expander e10.

[Sequence sq41] The server 20 specifies the LUN number “4000” corresponding to the disk d00 and issues SSP Read to the upper-level expander 301 (here, expander e00). At this time, if the server 20 has acquired the recommended access path, the server 20 issues SSP Read to the upper-level expander 301 in accordance with the recommended access path.

[Sequence sq42] If reception of the first SCSI command to the LUN number “4000” is made or if a change is made in the recommended access path, the expander e00 notifies the server 20 of the state change of the access path. For example, the expander e00 notifies the server 20 of SCSI Sence of SK/SC/SS=06/2A/06 (ASYMMETRIC ACCESS STATE CHANGED). The expander e00 can thereby notify the server 20 of that a change is present in the recommended access path (state change of the access path).

[Sequence sq43] The server 20 requests the state of the access path to the expander e00.

[Sequence sq44] The expander e00 notifies the server 20 of the recommended access path of the requested access path (e.g. LUN number “4000”).

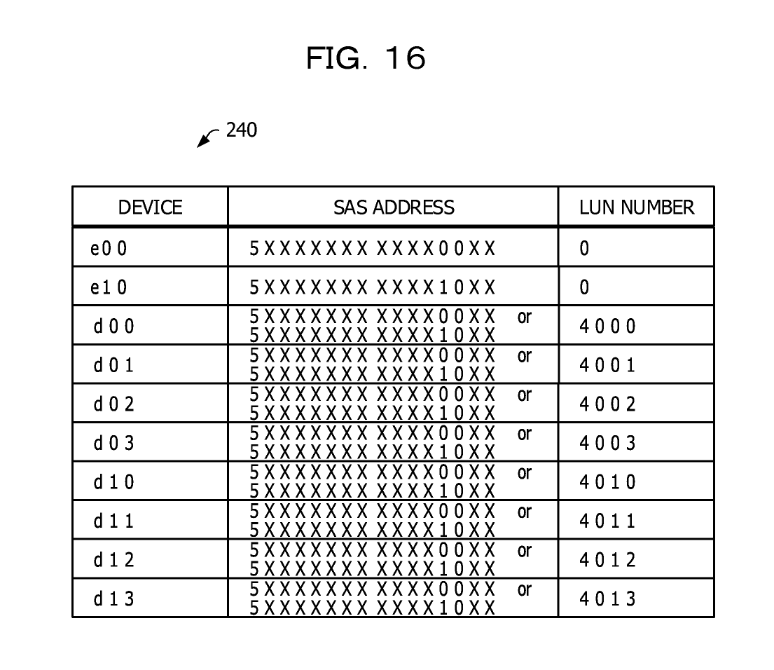

Here, a description will be made by using FIG. 16 about a method for allowing the server 20 to recognize the respective devices possessed by the DE 10 when the server 20 receives the notification of the recommended access path. FIG. 16 illustrates one example of an access device specifying list of the second embodiment.

According to an access device specifying list 240, the server 20 can access the expander 30 by the SAS address. For example, the server 20 accesses the expander e00 by the SAS address “5XXXXXXX XXXX00XX.” The server 20 can thereby access the expander e00 and acquire the state of the DE 10.

Furthermore, according to the access device specifying list 240, the server 20 can access the disk 50 as a logical volume associated with the upper-level expander 301 by using the SAS address of the upper-level expander 301. For example, the server 20 can access the disk d00 by accessing the upper-level expander 301 with use of the SAS address and specifying the LUN number “4000.”

For example, conventionally, the server 20 accesses the disk 50 by directly specifying the disk 50 with use of information like the SAS address “5XXXXXXX XXXXXX00”+ the LUN number “0 (default value)” of the disk d00. According to the access device specifying list 240, the server 20 can access the disk 50 by indirectly specifying the disk 50 with use of information like the SAS address “5XXXXXXX XXXX00XX” of the expander e00+ the LUN number “4000” of the disk d00.

At this time, the server 20 can access the expander e00 when using the SAS address “5XXXXXXX XXXX00XX” and can access the expander e10 when using the SAS address “5XXXXXXX XXXX10XX.” That is, the server 20 can access the disk d00 via the expander e00 or via the expander e10. The recommended access path is the access path via the upper-level expander 301 recommended as the access destination when the server 20 accesses the disk d00.

Let us return to the description of the command sequence illustrated in FIG. 15 again. For example, suppose that the change of the recommended access path corresponding to the LUN number “4000” is the change from the access path via the expander e00 to the access path via the expander e10.

[Sequence sq45] The server 20 specifies the LUN number “4000” corresponding to the disk d00 and issues SSP Read to the expander e10 in accordance with the recommended access path.

[Sequence sq46] The expander e10 refers to the LUN number management table 200 and acquires the SAS address “5XXXXXXX XXXXXX00” of the disk d00 from the LUN number “4000.” The expander e10 specifies the SAS address “5XXXXXXX XXXXXX00” and issues SSP Read to the disk d00.

[Sequence sq47] The disk d00 returns SSP Read as a response to the expander e10.

[Sequence sq48] The expander e10 transfers the SSP Read response to the server 20.

In this manner, the upper-level expander 301 relays the access of the server 20 and the disk 50, which allows the DE 10 to implement the access from the server 20 to the disk 50 by the recommended access path.

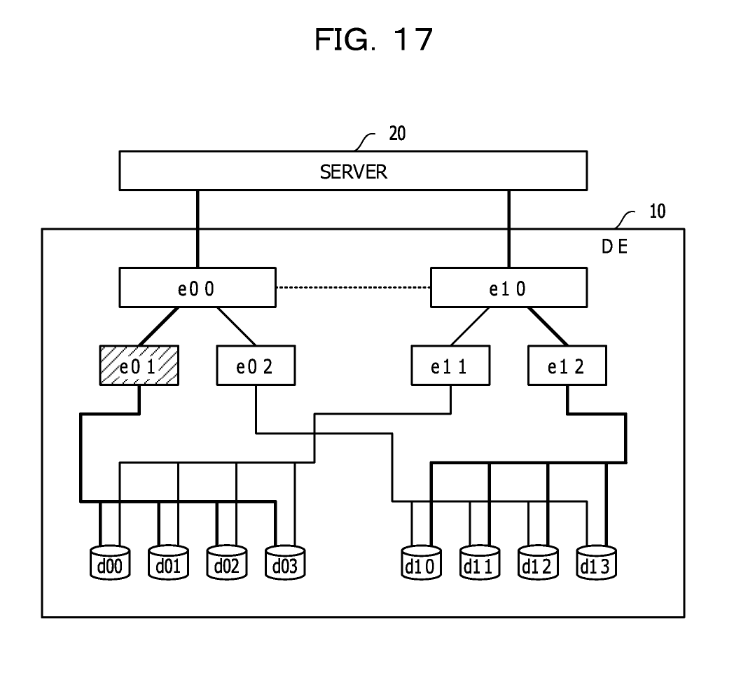

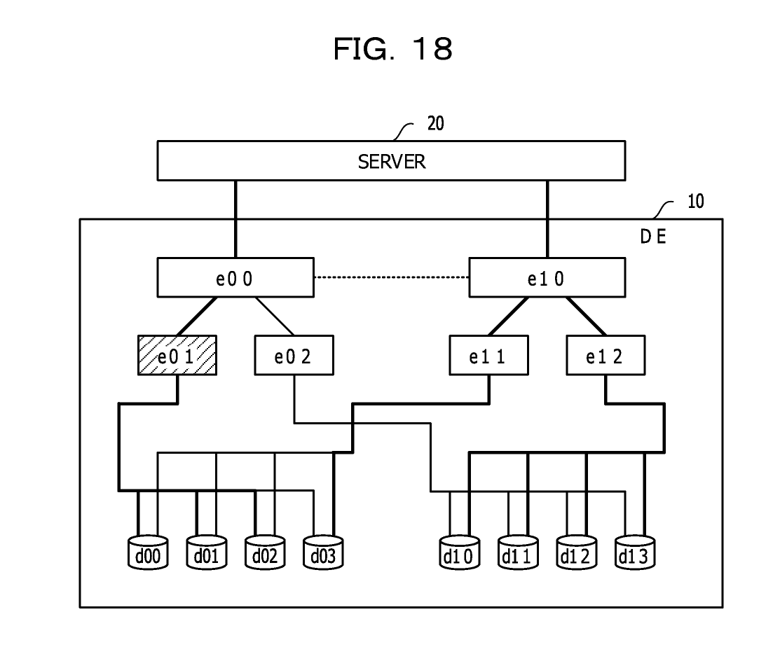

Next, an example of distribution of the access load in the DE 10 will be described by using FIGS. 17 and 18. FIGS. 17 and 18 illustrate one example of recommended access paths in the DE 10 of the second embodiment.

For example, FIG. 17 illustrates a case in which the server 20 newly carries out disk access via the expander e00 in a state in which continuous access is made from the server 20 to the disks d10, d11, d12, and d13 via the expanders e10 and e12. The server 20 makes access to the disks d00, d01, d02, and d03 via the expanders e00 and e01. Here, the expander e01 serves as the master. Thus, the expanders e00 and e10 detect the overload of the expander e01 and decide the recommended access path that distributes part of the access load of the expander e01 to the expander e11. For example, the expanders e00 and e10 update the recommended access path of the disk d03 from the access path via the expander e00 to the access path via the expander e10.

Due to this, the expander e00 notifies the server 20 of the recommended access path via the expander e10, with a request for access to the disk d03 by the server 20 serving as the trigger. Receiving the recommended access path via the expander e10, the server 20 accesses the disk d03 via the expander e10 as illustrated in FIG. 18. In this manner, the DE 10 can distribute the access load.

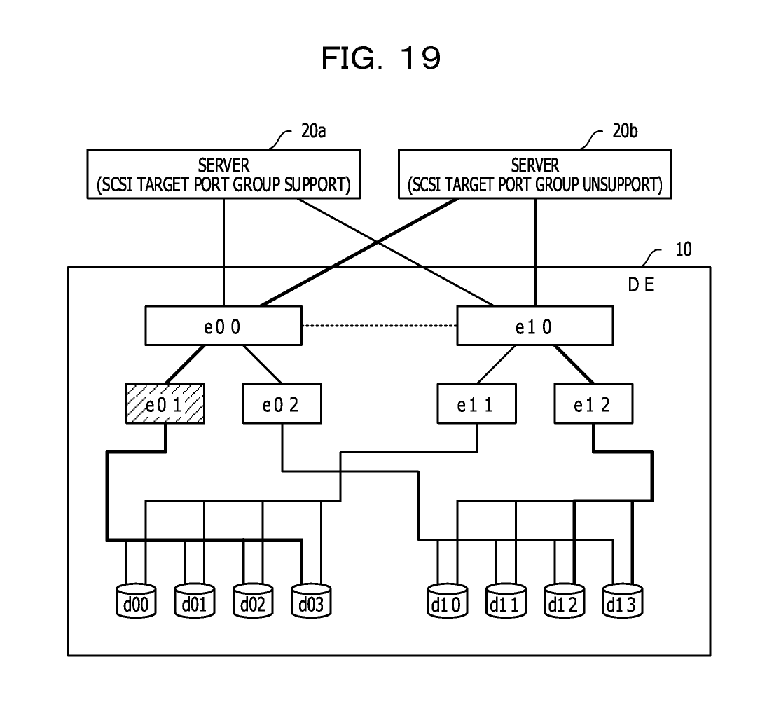

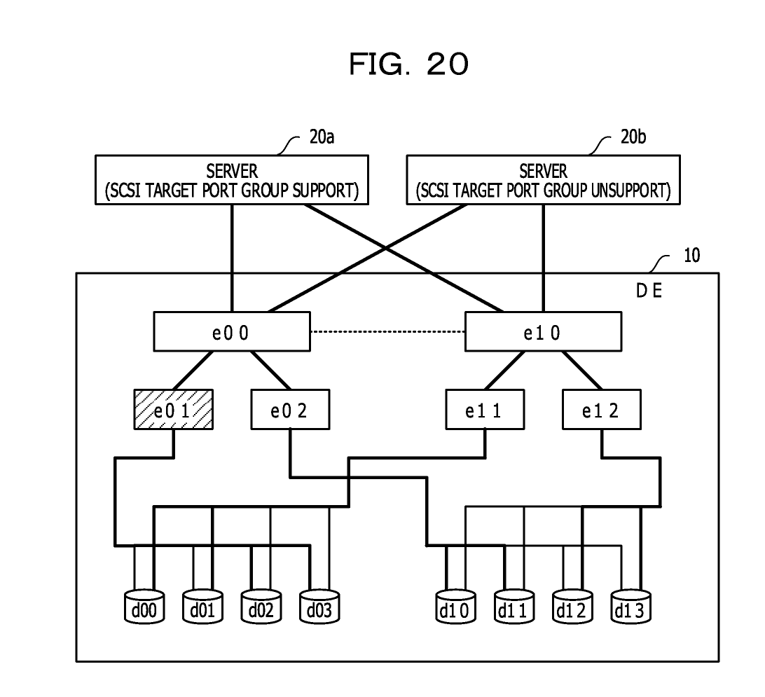

Next, a description will be made by using FIGS. 19 and 20 about an example of distribution of the access load carried out by the DE 10 in a storage system in which a support server that supports SCSI Target Port Group and an unsupport server that does not support SCSI Target Port Group exist in a mixed manner. FIGS. 19 and 20 illustrate one example of recommended access paths in the DE 10 of the second embodiment.

The DE 10 illustrated in FIGS. 19 and 20 is coupled to a server 20a that supports SCSI Target Port Group and a server 20b that does not support SCSI Target Port Group. It is difficult for the DE 10 to carry out load distribution about access from the server 20b. However, in the case in which the server 20a is coupled to the DE 10 in conjunction with the server 20b, the DE 10 can carry out load distribution by controlling access of the server 20a.

For example, FIG. 19 illustrates a state in which continuous access is made from the server 20b to the disks d02 and d03 via the expanders e00 and e01 and from the server 20b to the disks d12 and d13 via the expanders e10 and e12.

Here, suppose that the server 20a newly accesses the disks d00, d01, d10, and d11. At this time, because command reception is absent in the expanders e02 and e11, the DE 10 notifies the server 20a of the recommended access paths via the expanders e02 and e11.

This allows the server 20a to carry out disk access via the expanders e02 and e11 as illustrated in FIG. 20. Therefore, even when an unsupport server exists in a mixed manner in the servers 20 of the coupling destinations, the DE 10 can distribute the access load and efficiently make relays to the disks 50.

Although the embodiments are exemplified above, the configurations of the respective parts illustrated in the embodiments can be replaced by other objects having similar functions. Furthermore, another arbitrary constituent object or step may be added.

The above-described processing functions can be implemented by a computer. In this case, a program that describes the contents of processing of functions that may be possessed by the first relay device 3, the second relay device 4, the storage apparatus 2, the DE 10, and the expander 30 is provided. By executing the program by the computer, the above-described processing functions are implemented on the computer. The program that describes the contents of the processing can be recorded in a computer-readable recording medium. As the computer-readable recording medium, a magnetic memory device, an optical disk, a magneto-optical recording medium, a semiconductor memory, and so forth are available. Among the magnetic memory devices are a hard disk drive (HDD), a flexible disk (FD), a magnetic tape, and so forth. Among the magneto-optical recording media are a magneto-optical (MO) disk and so forth.

In the case of distributing the program, portable recording media such as DVD and CD-ROM in which the program is recorded are sold. Furthermore, it is also possible to store the program in a memory device of a server computer and transfer the program from the server computer to other computers via a network.

The computer that executes the program stores the program recorded in a portable recording medium or the program transferred from a server computer in its own memory device for example. Then, the computer reads the program from its own memory device and executes processing in accordance with the program. It is also possible for the computer to read the program directly from the portable recording medium and execute processing in accordance with the program. Furthermore, it is also possible for the computer to sequentially execute processing in accordance with a received program every time the program is transferred from a server computer coupled via a network.

Moreover, it is also possible to implement at least part of the above-described processing functions by an electronic circuit such as a DSP, ASIC, or PLD.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A system comprising:
a first relay device including a first memory and configured to make a relay between a plurality of storage devices and an external device by a first channel; and
a second relay device including a second memory and configured to make a relay between the plurality of storage devices and the external device by a second channel different from the first channel,
wherein
each of the first memory and the second memory is configured to store a correspondence relationship between first specifying destination information for executing access to a storage device in the plurality of storage devices and second specifying destination information for relaying access from the external device to the storage device to execute access to the storage device, and
each of the first relay device and the second relay device is configured to:
determine a relay route via one of the first relay device or the second relay device about each of pieces of the second specifying destination information corresponding to the plurality of storage devices based on a relay load,
notify the external device of the determined relay route,
receive, from the external device, an access request allowed to be identified by the second specifying destination information determined in the external device based on the notified relay route, and
execute processing relating to access to the storage device based on the first specifying destination information based on the access request and the correspondence relationship.

2. The system according to claim 1, wherein each of the first relay device and the second relay device is configured to:
when the relay route is changed by the determining of the relay route, notify the external device of the determined relay route in response to the receiving of the access request from the external device to the storage device.

3. The system according to claim 1, wherein
the first relay device includes:
a first lower-level relay device configured to make a relay between a first storage device group in the plurality of storage devices and the first relay device, and
a second lower-level relay device configured to make a relay between a second storage device group different from the first storage device group in the plurality of storage devices and the first relay device, and
the second relay device includes:
a third lower-level relay device configured to make a relay between the first storage device group and the second relay device, and
a fourth lower-level relay device configured to make a relay between the second storage device group and the second relay device.

4. The system according to claim 3, wherein the relay load includes a processing load of each of the first relay device, the second relay device, the first lower-level relay device, the second lower-level relay device, the third lower-level relay device, and the fourth lower-level relay device.

5. The system according to claim 1, wherein each of the first relay device and the second relay device is configured to:
generate the correspondence relationship in which identification information of a logical volume corresponding to the storage device is specified in the second specifying destination information.

6. The system according to claim 1, wherein the relay load includes a communication load of relays by the first relay device and the second relay device.

7. The system according to claim 1, wherein the system includes the plurality of storage devices.

8. A method executed by a first relay device and a second relay device in a system, the first relay device being configured to make a relay between a plurality of storage devices and an external device by a first channel, the second relay device being configured to make a relay between the plurality of storage devices and the external device by a second channel different from the first channel, the method comprising:
referring a correspondence relationship between first specifying destination information for executing access to a storage device in the plurality of storage devices and second specifying destination information for relaying access from the external device to the storage device to execute access to the storage device;
determining a relay route via one of the first relay device or the second relay device about each of pieces of the second specifying destination information corresponding to the plurality of storage devices based on a relay load;
notifying the external device of the determined relay route;
receiving, from the external device, an access request allowed to be identified by the second specifying destination information determined in the external device based on the notified relay route; and
executing processing relating to access to the storage device based on the first specifying destination information based on the access request and the correspondence relationship.

9. The method according to claim 8, wherein
when the relay route is changed by the determining of the relay route, the notifying notifies the external device of the determined relay route in response to the receiving of the access request from the external device to the storage device.

10. The method according to claim 8, wherein
the first relay device includes:
a first lower-level relay device configured to make a relay between a first storage device group in the plurality of storage devices and the first relay device, and
a second lower-level relay device configured to make a relay between a second storage device group different from the first storage device group in the plurality of storage devices and the first relay device, and
the second relay device includes:
a third lower-level relay device configured to make a relay between the first storage device group and the second relay device, and
a fourth lower-level relay device configured to make a relay between the second storage device group and the second relay device, and
the relay load includes a processing load of each of the first relay device, the second relay device, the first lower-level relay device, the second lower-level relay device, the third lower-level relay device, and the fourth lower-level relay device.

11. The method according to claim 8, further comprising:
generating the correspondence relationship in which identification information of a logical volume corresponding to the storage device is specified in the second specifying destination information.

12. The method according to claim 8, wherein the relay load includes a communication load of relays by the first relay device and the second relay device.

13. A relay device in a plurality of relay devices used in a system, the relay device being configured to make a relay between a plurality of storage devices and an external device by a first channel, an another relay device in the plurality of relay devices being configured to make a relay between the plurality of storage devices and the external device by a second channel different from the first channel, the relay device comprising:
a memory configured to store a correspondence relationship between first specifying destination information for executing access to a storage device in the plurality of storage devices and second specifying destination information for relaying access from the external device to the storage device to execute access to the storage device; and
a processor coupled to the memory and configured to:
determine a relay route via one of the relay device or the another relay device about each of pieces of the second specifying destination information corresponding to the plurality of storage devices based on a relay load,
notify the external device of the determined relay route,
receive, from the external device, an access request allowed to be identified by the second specifying destination information determined in the external device based on the notified relay route, and
execute processing relating to access to the storage device based on the first specifying destination information based on the access request and the correspondence relationship.

14. The relay device according to claim 13, wherein the processor is configured to:
when the relay route is changed by the determining of the relay route, notify the external device of the determined relay route in response to the receiving of the access request from the external device to the storage device.

15. The relay device according to claim 13, wherein
a first lower-level relay device configured to make a relay between a first storage device group in the plurality of storage devices and the first relay device; and
a second lower-level relay device configured to make a relay between a second storage device group different from the first storage device group in the plurality of storage devices and the first relay device.

16. The relay device according to claim 15, wherein the relay load includes a processing load of each of the first relay device, the second relay device, the first lower-level relay device, the second lower-level relay device, the third lower-level relay device, and the fourth lower-level relay device.

17. The relay device according to claim 13, wherein the processor is configured to:
generate the correspondence relationship in which identification information of a logical volume corresponding to the storage device is specified in the second specifying destination information.

18. The relay device according to claim 13, wherein the relay load includes a communication load of relays by the relay device and the another relay device.
